(19) United States
(12) Patent Application Publication
(10) Pub. No.: US 2002/0046297 A1
(43) Pub. Date: Apr. 18, 2002

(54) System containing a plurality of central processing units

(76) Inventor: Jain Raj Kumar, Singapore (SG)

Correspondence Address: LERNER AND GREENBERG, P.A., Post Office Box 2480, Hollywood, FL, 33022-2480, US

(21) Appl. No.: 09/886,558

(22) Filed: Jun. 21, 2001

(30) Foreign Application Priority Data
Jun. 21, 2000 (DE) 100 30 380.3

(51) Int. Cl. G06F 15/16

(52) U.S. Cl. 709/253

(57) ABSTRACT

A common memory is provided for a plurality of CPUs. Only one or several particular ones of the CPUs are connected to an address bus provided for addressing the common memory. The other CPUs access the common memory via one of the CPUs connected to the address bus. This means that the system requires only relatively short buses and/or buses with little branching, even though the system has a common memory.

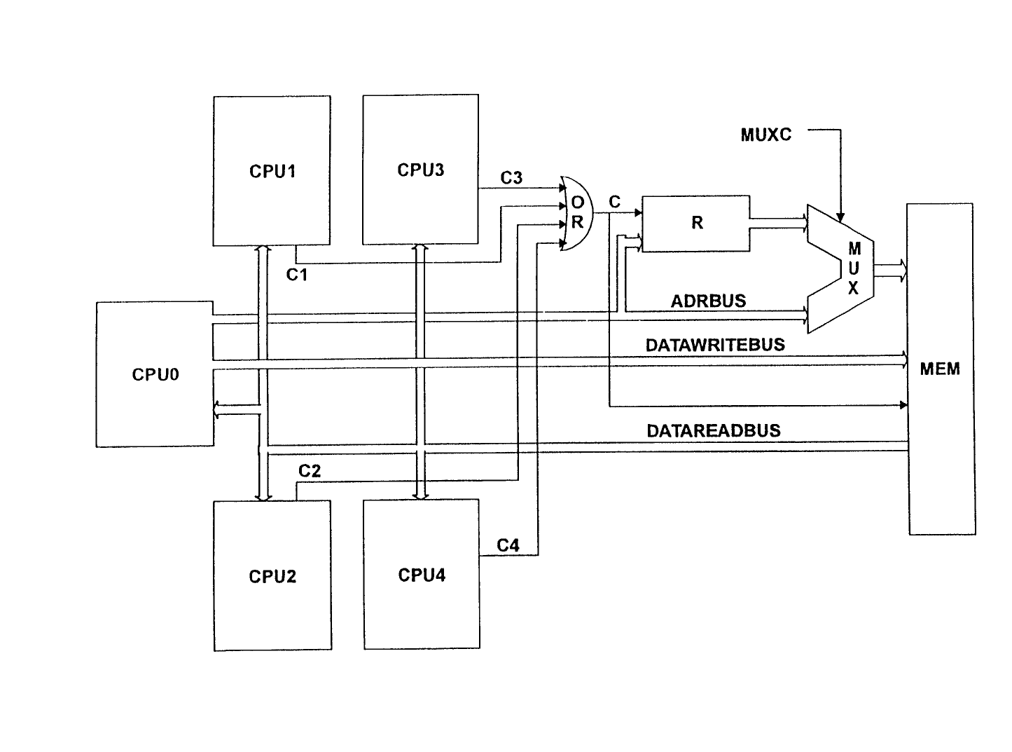

### BACKGROUND OF THE INVENTION

Field of the Invention

The invention relates to a system including a plurality of CPUs (Central Processing Units).

Such systems have been known for many years in a wide variety of embodiments.

A known problem of such systems is that their configuration and operation is generally very complex.

The reason for this, among other things, is that each CPU is provided with a dedicated memory storing the programs and data required by the relevant CPU. This is disadvantageous because it may be required that particular data are stored in a plurality of memories, that is to say stored a plurality of times, and/or it may be required that some of the data stored in the memories must be kept in a coordinated form.

One possible alternative to this is to provide a common memory for all the CPUs. However, this is associated with significant other drawbacks. A connection of the CPUs to the common memory generally requires very long buses with extensive branching, and it is also necessary to provide a control device regulating the bus allocation.

### SUMMARY OF THE INVENTION

It is accordingly an object of the invention to provide a CPU system which overcomes the above-mentioned disadvantages of the heretofore-known systems of this general type and which is of simple configuration and is easy to operate.

With the foregoing and other objects in view there is provided, in accordance with the invention, a CPU system, including:

a plurality of CPUs;

a common memory provided for the plurality of CPUs;

an address bus for addressing the common memory;

at least one of the CPUs being connected to the address bus; and

other ones of the CPUs accessing the common memory via the at least one of the CPUs connected to the address bus.

In other words, the system according to the invention is distinguished in that:

a common memory is provided for the plurality of CPUs,

of the plurality of CPUs, only one or more particular CPUs are connected to the address bus provided for addressing the common memory, and

the other CPUs access the common memory via one of the CPUs connected to the address bus.

These features mean that the system requires only relatively short buses and/or buses with little branching, even though it has a common memory, and that access to the common memory can be controlled relatively easily and flexibly.

The claimed system can thus be constructed and operated with relatively little outlay.

Another embodiment of the invention includes a data bus connected to at least one of the CPUs; and the common memory outputs, via the data bus, data read from the common memory.

Yet another embodiment of the invention includes a data bus connected to at least one of the CPUs; and the data bus supplies data to the common memory for being written into the common memory.

A further embodiment of the invention includes a data read bus connected to the common memory for outputting data read from the common memory; a data write bus connected the common memory for supplying data to be written into the common memory; the plurality of CPUs includes a given subset of CPUs not connected to the address bus; and at least some CPUs of the given subset of CPUs are connected to the data read bus and/or the data write bus.

Another embodiment of the invention includes a switching apparatus operatively connected to the common memory; an address memory device operatively connected to the switching apparatus; and the switching apparatus selectively supplies data output to the address bus by the at least one of the CPUs connected to the address bus and data stored in the address memory device to the common memory as an address.

According to another feature of the invention, the switching apparatus is a multiplexer having a first input connection, a second input connection, and an output connection; the first input connection is connected, via the address bus, to the at least one of the CPUs connected to the address bus; the second input connection is connected to the address memory device; and the output connection is connected to the common memory.

According to yet another feature of the invention, the switching apparatus is controlled by the at least one of the CPUs connected to the address bus.

According to a further feature of the invention, the address memory device is connected to the address bus and stores addresses; and the at least one of the CPUs connected to the address bus outputs the addresses stored in the address memory device to the address bus.

According to yet another feature of the invention, the plurality of CPUs includes given CPUs not connected to the address bus; and the address memory device has a content, the given CPUs not connected to the address bus are configured to increment the content of the address memory device.

According to a further feature of the invention, the plurality of CPUs includes given CPUs not connected to the address bus; and the given CPUs not connected to the address bus prompt the common memory to perform an operation selected from the group consisting of reading data from the common memory and writing data to the common memory.

Another embodiment of the invention includes a memory connectable to the given CPUs not connected to the address bus; the given CPUs not connected to the address bus outputting addresses for addressing the memory; and the common memory being configured such that a given signal prompts the common memory to perform an operation selected from the group consisting of reading data from the common memory and writing data to the common memory, the given signal having a profile depending on the addresses output by the CPUs not connected to the address bus.

According to another feature of the invention, the common memory is configured such that a given signal prompts the common memory to perform an operation selected from the group consisting of reading data from the common memory and writing data to the common memory, the given signal results from a logic combination of specific signals originating from given ones of the plurality of CPUs having a capability of prompting an operation selected from the group consisting of reading data from the common memory and writing data to the common memory, and the specific signals indicating, for each individual one of the plurality of CPUs, whether the individual one of the CPUs wishes to prompt an operation selected from the group consisting of reading data from the common memory and writing data to the common memory.

According to another feature of the invention, the common memory is configured such that a given signal prompts the common memory to perform an operation selected from the group consisting of reading data from the common memory and writing data to the common memory, the given signal results from a logic combination of specific signals originating from devices associated with given ones of the plurality of CPUs having a capability of prompting an operation selected from the group consisting of reading data from the common memory and writing data to the common memory, and the specific signals indicating, for each individual one of the plurality of CPUs, whether the individual one of the CPUs wishes to prompt an operation selected from the group consisting of reading data from the common memory and writing data to the common memory.

Another embodiment of the invention includes an address memory device operatively connected to the switching apparatus, the address memory device having a memory content; the common memory is configured such that a given signal prompts the common memory to perform an operation selected from the group consisting of reading data from the common memory and writing data to the common memory; and the address memory device is configured such that the given signal also prompts the address memory device to increment the memory content.

According to another feature of the invention, one of the other ones of the CPUs not connected to the address bus transmits data or an adddress indicating to a relevant one of the plurality of CPUs a start for an operation selected from the group consisting of reading data from the common memory and writing data to the common memory, when one of the plurality of CPUs, which is to be used for an access and is connected to the address bus, accesses the common memory.

Another embodiment of the invention includes a switching apparatus operatively connected to the common memory; an address memory device operatively connected to the switching apparatus; a given one of the plurality of CPUs, which is used for the operation selected from the group consisting of reading data from the common memory and writing data to the common memory, outputs, to the address bus, the start address indicating a start for the operation selected from the group consisting of reading data from the common memory and writing data to the common memory; the given one of the plurality of CPUs, which is used for the operation selected from the group consisting of reading data from the common memory and writing data to the common memory, drives the switching apparatus such that data stored in the address memory device are supplied to the common memory as an address; and the given one of the plurality of CPUs, which is used for the operation selected from the group consisting of reading data from the common memory and writing data to the common memory, notifying a specific one of the plurality of CPUs, which requested access to the common memory, that the specific one of the plurality of CPUs is allowed to perform an operation selected from the group consisting of reading data from the common memory and writing data to the common memory.

According to another feature of the invention, the other ones of the CPUs output signals, the signals represent addresses and are used as control signals for controlling system components.

According to a further feature of the invention, the other ones of the CPUs output signals, the signals represent addresses and are converted into control signals for controlling system components.

Another embodiment of the invention includes a data bus connected to the address memory device; the common memory outputting data read therefrom via the data bus; and the address memory device outputting a content stored therein to the data bus when prompted by one of the CPUs.

According to another feature of the invention, the address memory device is configured such that a signal for prompting the address memory device to output the content stored therein to the data bus has a signal profile dependent on addresses output by given ones of the CPUs, which are not connected to the address bus, for addressing memories connectable thereto.

With the objects of the invention in view there is also provided, an a CPU system, including:

a plurality of CPUs including a first subset of CPUs and a second subset of CPUs;

a common memory provided for the plurality of CPUs;

an address bus for addressing the common memory;

only the first subset of CPUs being connected to the address bus; and

the second subset of CPUs accessing the common memory via the first subset of CPUs.

Other features which are considered as characteristic for the invention are set forth in the appended claims.

Although the invention is illustrated and described herein as embodied in a CPU system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single figure of the drawing is a block diagram of an exemplary embodiment of a CPU system according to the invention.

### DESCRIPTION OF THE PREFERRED EMBODIMENTS

Referring now to the single figure of the drawing in detail, there is schematically shown the configuration of the system according to the invention which will be described in more detail below.

The system under consideration contains five CPUs. Before continuing, however, it should be pointed out that there is no restriction to this number. The special features of the system under consideration which are described in more detail below can also be used in systems having any greater or smaller number of CPUs.

The CPUs in the system under consideration are accommodated on a single semiconductor chip. The semiconductor chip is a signal processor which processes, in parallel, data received via a plurality of channels. There is also no restriction to this. The semiconductor chip, whose component part is the CPUs, may also be any other module, for example a microprocessor or microcontroller. In addition, there is also no need for the plurality of CPUs to be accommodated on a single semiconductor chip; the special features of the system under consideration which are described in more detail below are also found to be advantageous when the CPUs are distributed over a plurality of different components or component groups.

The plurality of CPUs may be of the same or a different configuration.

The five CPUs in the system under consideration are denoted by the reference symbols CPU0 to CPU4 in the figure.

These five CPUs are provided with a single memory which is common to all the CPUs; this memory is denoted by the reference symbol MEM in the figure.

The common memory MEM is connected via

an address bus ADRBUS provided for addressing the memory, p0 a data bus DATAWRITEBUS provided for transmitting data which are to be written to the memory,

a data bus DATAREADBUS provided for transmitting data which are to be read from the memory, and

various control lines (shown only in part in the figure) for controlling the memory, in particular lines via which requests for reading (read request signal) or writing data (write request signal) are transmitted to the memory, to the other components of the system shown in the figure.

Besides the aforementioned CPUs CPU0 to CPU4, these other components are an OR-gate OR, an address memory device, which is realized by a register R in the example under consideration, and a switching device, which is realized by a multiplexer MUX in the example under consideration.

The address bus ADRBUS includes two parts: a first part, which runs between the CPU CPU0, the register R and one of the input connections of the multiplexer MUX and connects these together, and a second part, which runs between the output connection of the multiplexer MUX and the memory MEM and connects these together.

The data bus DATAWRITEBUS runs between the CPU CPU0 and the memory MEM and connects these together.

The data bus DATAREADBUS runs between the CPUs CPU, CPU1, CPU2, CPU3, CPU4 and the memory MEM and connects these together.

The multiplexer MUX has two input connections and an output connection. As has already been mentioned, the first input connection is connected to the CPU CPU0 via the first part of the address bus ADRBUS, and the output connection is connected to the memory MEM via the second part of the address bus ADRBUS. The second input connection of the multiplexer MUX is connected to the register R via a bus which is not shown in more detail in the figure. The multiplexer MUX is controlled by a control signal which is denoted by the reference symbol MUXC in the figure. The control signal MUXC decides whether the data transmitted via the first part of the address bus ADRBUS (data output from the CPU CPU0) or the data stored in the register R are used as the address which determines which data need to be read from the memory or to what location data which are to be written to the memory need to be written. As already mentioned, the register R,

can be written to by the CPU CPU0 via the first part of the address bus ADRBUS,

can increment its content when prompted by a control signal C, and

outputs its content to the second input connection of the multiplexer MUX.

In the example under consideration, the control signal C prompting the register content to be incremented is used at the same time as a read request signal supplied to the memory MEM, which read request signal prompts the memory MEM to read the data stored at the address supplied to it via the address bus ADRBUS and to output them via the data bus DATAREADBUS.

Before continuing, it should be pointed out that it is also possible for various control signals to increment the register content and to prompt the memory MEM to read out data.

It should also be pointed out that the control signal C prompting the register content to be incremented may alternatively be used at the same time as a write request signal supplied to the memory MEM, which write request signal prompts the memory MEM to store the data supplied to it via the data bus DATAWRITEBUS at the address supplied to it via the address bus ADRBUS; this is found to be advantageous, for example, if the CPUs which are not connected to the address bus ADRBUS carry out or need to carry out write access operations frequently and/or efficiently, and for this reason are not connected to the DATAREADBUS, but instead to the DATAWRITEBUS.

In the present case, the control signal is formed by the OR-gate OR; the OR-gate OR subjects control signals C1 to C4 which are supplied to it to an OR function and outputs the result to the register R and to the memory MEM as the aforementioned control signal C.

The signals C1 to C4 originate from the CPUs CPU1 to CPU4 which are not connected to the address bus ADRBUS, or from devices associated with the CPUs, and signal whether the respective CPUs wish to prompt reading of data from the memory.

In the example under consideration, the signals C1 to C4 depend on the addresses output by the CPUs CPU1 to CPU4 which are not connected to the address bus ADRBUS.

Like other CPUs, the CPUs CPU1 to CPU4 output addresses for addressing a memory which can be connected thereto. However, since the CPUs CPU1 to CPU4 do not have associated dedicated memories and are also not connected to the address bus ADRBUS for the purpose of addressing the common memory MEM, the aforementioned addresses are not required for memory addressing and can be used otherwise. In the example under consideration, the address signals of the CPUs CPU1 to CPU4, or signals formed on the basis thereof, are used for controlling the memory MEM, the register R and/or other system components, these signals being able, in principle, to control any system components in an arbitrary manner.

In the example under consideration, it may be assumed that the CPUs CPU1 to CPU4 signal, by outputting an address 8000 (hex), that they want to prompt the common memory MEM to read the data stored at the address which is supplied to it (and is stored in the register R) and to output them to the data bus DATAREADBUS. In this case, the signals C1 to C4 are produced by address comparison devices which are provided within or outside the CPUs CPU1 to CPU4 and check whether the addresses output by the relevant CPUs have the value 8000; under some circumstances, it is also possible for the 16th bits of the addresses output by the relevant CPUs to be used immediately as the signals C1 to C4.

If one of the signals C1 to C4 signals that memory access is to take place, the control signal C adopts a value which

prompts the common memory MEM to output the data stored at the address supplied to it (stored in the register R) to the data bus DATAREADBUS, and

prompts the register R to increment its content.

This allows the CPUs CPU1 to CPU4 to read out a memory area of any size by repeatedly outputting the address 8000.

A similar situation naturally also applies when the CPUs CPU1 to CPU4 signal, by outputting any other address or by setting or resetting one or more other address bits, that they want to prompt the memory to output data and that they want to prompt the register R to increment the register content.

It is also possible to provide for the CPUs CPU1 to CPU4 to control other system components by outputting other addresses or setting or resetting other address bits.

For the sake of completeness, it should be noted that the signals C1 to C4 can also be produced in any other way; in particular, there is no need for these signals to be formed on the basis of the addresses output by the CPUs.

As already suggested by the configuration of the system under consideration, the CPU CPU0 has a particular function: as described more precisely below, all the access operations to the memory MEM by the CPUs which are present are performed using the CPU CPU0. In the example under consideration, it has no other function, but may naturally also perform any other tasks.

The CPU CPU0 is the only one of the CPUs present which can address the memory MEM without restriction: only this CPU is connected to the memory MEM via the address bus ADRBUS, and it uses the control signal MUXC which it produces to determine whether the data present on the address bus or the data stored in the register R are used as address.

If one of the other CPUs CPU1 to CPU4 requires data from the memory MEM, it notifies the CPU CPU0 of this (via connecting lines (not shown in the figure) between the CPUs), specifying information about where the required data are stored in the memory.

The information about the location at which the required data are stored may be any information, for example

the address to be applied to the memory MEM,

a code specifying an address stored in the CPU CPU0, and/or

an offset with respect to an address stored in the CPU CPU0.

The way in which this information is transmitted to the CPU CPU0, i.e. in particular whether serial or parallel transmission takes place, is subject to no restrictions.

If the CPU CPU0 receives a notification from one of the CPUs CPU1 to CPU4 that it requires data from the memory MEM,

it outputs the address at which the required data are stored in the memory MEM to the address bus ADRBUS and ensures that this address is transferred to the register R,

it sets the control bit MUXC controlling the multiplexer MUX to a value which prompts the multiplexer MUX to switch through the data stored in the register R, and

it confirms to the CPU requesting the reading of the memory MEM that the precautions required for the desired reading are being or have been met.

The CPU requesting that the memory MEM be read then produces a control signal which signals the read request, namely the signal Cx (i.e. C1 or C2 or C3 or C4), and can then read the required data from the memory MEM. The result of outputting the control signal Cx is that

the memory MEM reads the data stored at the address which is in the register R and outputs them via the data bus DATAREADBUS, and

the content of the register R (the address stored therein) is incremented.

If the CPU requesting that the memory MEM be read then outputs another control signal Cx, the result of this is that

the memory MEM reads the data stored at the incremented address which is in the register R and outputs them via the data bus DATAREADBUS, and

the content of the register R (the address stored therein)

is incremented again.

This operation (output of the control signal Cx by the CPU requesting that the memory MEM be read) can be repeated as often as desired. This means that the relevant CPU can read any amount of data from the memory MEM.

When the CPU reading the memory MEM requires no further data, it notifies the CPU CPU0 of this, and the CPU CPU0 can then allow another CPU to read data from the memory MEM.

The time at which the CPU CPU0 allows which CPU to read data from the memory MEM can, in principle, be stipulated in any desired manner. In the example under consideration, access authorization is allocated on the basis of the “round robin” method, which assigns the same priority to all the CPUs.

Reading data stored in the memory MEM in the manner described above allows the system to have an extremely simple configuration: in particular, there is now no need for the address bus, via which the memory MEM receives the address from which it is to read or to which it is to write, to be connected to all the CPUs; it is sufficient for the address bus to be connected to the CPU which organizes reading of the memory MEM (to the CPU0 in the example under consideration). This allows the length of the address bus ADRBUS and the number of system components which it needs to connect to be reduced to a minimum. That the other CPUs can no longer access the memory entirely independently, but rather only via a CPU organizing reading of the memory, represents no significant drawback in practice. Although the fact that the address is output to the address bus not by the CPU which requires the data but rather by a CPU organizing the data access can sometimes result in a delay, this is a one-off delay which occurs only a single time per read operation, irrespective of the volume of data which is read from the memory. Correspondingly, there is now no need to provide a bus control device controlling the bus allocation.

Since, as has already been mentioned above, only the CPU CPU0 is able to address the memory MEM without restriction, data can also be written to the memory MEM only with the cooperation of the CPU CPU0.

In the example under consideration, it is assumed that writing to the memory MEM needs to be carried out very rarely. For this reason, the data bus DATAWRITEBUS, via which the data to be stored in the memory MEM are transmitted thereto, is likewise connected only to the CPU CPU0; the CPUs CPU1 to CPU4 are not connected to the data bus DATAWRITEBUS.

The CPUs CPU1 to CPU4 are thus not able to write data to the memory MEM. If one of the CPUs CPU1 to CPU4 needs to write data to the memory MEM, this must be done entirely using the CPU CPU0. To this end, the CPU which needs to write data to the memory MEM transfers the data which are to be written to the memory and the address at which these data need to be stored to the CPU0 and leaves this CPU to write the transmitted data to the memory MEM.

For the sake of completeness, it should be noted that between the CPU CPU0 and the memory MEM a control line (not shown in the figure) is provided which the CPU CPU0 uses to signal to the memory MEM that it needs to store the data transmitted via the data bus DATAWRITEBUS.

The fact that the data bus DATAWRITEBUS is also connected only to the CPU CPU0 means that the length of the data bus and the number of system components which need to be connected thereto can also be reduced to a minimum.

In the system under consideration, although a common memory is provided for a plurality of CPUs, only the data bus DATAREADBUS, via which data read from the memory are output, is connected to all the CPUs. The other buses, that is to say the address bus ADRBUS and the data bus DATAWRITEBUS, are connected only to a single CPU. This means that the length of the buses and the number of system components which need to be connected thereto can be reduced to a minimum.

It ought to be clear that the system shown in the figure and described with reference thereto can be modified in many respects. In particular, provision may be made

for the data bus DATAREADBUS also to be connected only to particular CPUs (this is useful if the CPUs CPU1 to CPU4 require data from the memory only rarely and/or if the timing for reading data from the memory is not critical), and/or

for the data bus DATAWRITEBUS to be connected to a plurality or to all of the CPUs which are present (this is useful if the CPUs CPU1 to CPU4 frequently need to write data to the memory and/or if data need to be written to the memory very quickly), and/or

for the address bus ADRBUS to be connected to more than only one CPU (this is useful if a plurality of CPUs need to access the common memory themselves with no restriction, and/or if access by the CPUs which are not connected to the address bus ADRBUS needs to be able to be effected via various other CPUs).

In principle, the address bus ADRBUS and the data buses DATAREADBUS and DATAWRITEBUS can be connected independently of one another to any number of arbitrarily selected CPUs.

Independently of this, it may be found to be advantageous if individual, a plurality or all of the CPUs are able to read the content of the register R. This can be implemented, for example, by virtue of the register R being connected to the data bus DATAREADBUS and outputting its content to the data bus DATAREADBUS when prompted by an appropriate control signal, the control signal being able to be produced in a similar manner as the aforementioned control signal C, that is to say on the basis of the addresses output by the CPUs.

Independently of this and independently of other details of the practical implementation, the system under consideration requires only relatively short buses and/or buses with little branching, even though it has a common memory, and is nevertheless relatively simple and flexible to control and operate.

I claim:

1. A CPU system, comprising:
a plurality of CPUs;
a common memory provided for said plurality of CPUs;
an address bus for addressing said common memory;
at least one of said CPUs being connected to said address bus; and
other ones of said CPUs accessing said common memory via said at least one of said CPUs connected to said address bus.

2. The CPU system according to claim 1, including:
a data bus connected to at least one of said CPUs; and
said common memory outputting, via said data bus, data read from said common memory.

3. The CPU system according to claim 1, including:
a data bus connected to at least one of said CPUs; and
said data bus supplying data to said common memory for being written into said common memory.

4. The CPU system according to claim 1, including:
a data read bus connected to said common memory for outputting data read from said common memory;
a data write bus connected said common memory for supplying data to be written into said common memory;
said plurality of CPUs including a given subset of CPUs not connected to said address bus; and
at least some CPUs of said given subset of CPUs being connected to at least one bus selected from the group consisting of said data read bus and said data write bus.

5. The CPU system according to claim 1, including:
a switching apparatus operatively connected to said common memory;
an address memory device operatively connected to said switching apparatus; and
said switching apparatus selectively supplying data output to said address bus by said at least one of said CPUs connected to said address bus and data stored in said address memory device to said common memory as an address.

6. The CPU system according to claim 5, wherein:
said switching apparatus is a multiplexer having a first input connection, a second input connection, and an output connection;
said first input connection is connected, via said address bus, to said at least one of said CPUs connected to said address bus;
said second input connection is connected to said address memory device; and
said output connection is connected to said common memory.

7. The CPU system according to claim 5, wherein said switching apparatus is controlled by said at least one of said CPUs connected to said address bus.

8. The CPU system according to claim 5, wherein:
said address memory device is connected to said address bus and stores addresses; and
said at least one of said CPUs connected to said address bus outputs the addresses stored in said address memory device to said address bus.

9. The CPU system according to claim 5, wherein:
said plurality of CPUs includes given CPUs not connected to said address bus; and
said address memory device has a content, said given CPUs not connected to said address bus being configured to increment the content of said address memory device.

10. The CPU system according to claim 1, wherein:
said plurality of CPUs includes given CPUs not connected to said address bus; and
said given CPUs not connected to said address bus prompt said common memory to perform an operation selected from the group consisting of reading data from said common memory and writing data to said common memory.

11. The CPU system according to claim 10, including:
a memory connectable to said given CPUs not connected to said address bus;
said given CPUs not connected to said address bus outputting addresses for addressing said memory; and
said common memory being configured such that a given signal prompts said common memory to perform an operation selected from the group consisting of reading data from said common memory and writing data to said common memory, the given signal having a profile depending on the addresses output by said CPUs not connected to said address bus.

12. The CPU system according to claim 10, wherein said common memory is configured such that a given signal prompts said common memory to perform an operation selected from the group consisting of reading data from said common memory and writing data to said common memory, the given signal results from a logic combination of specific signals originating from given ones of said plurality of CPUs having a capability of prompting an operation selected from the group consisting of reading data from said common memory and writing data to said common memory, and the specific signals indicating, for each individual one of said plurality of CPUs, whether said individual one of said CPUs wishes to prompt an operation selected from the group consisting of reading data from said common memory and writing data to said common memory.

13. The CPU system according to claim 10, wherein said common memory is configured such that a given signal prompts said common memory to perform an operation selected from the group consisting of reading data from said common memory and writing data to said common memory, the given signal results from a logic combination of specific signals originating from devices associated with given ones of said plurality of CPUs having a capability of prompting an operation selected from the group consisting of reading data from said common memory and writing data to said common memory, and the specific signals indicating, for each individual one of said plurality of CPUs, whether said individual one of said CPUs wishes to prompt an operation selected from the group consisting of reading data from said common memory and writing data to said common memory.

14. The CPU system according to claim 10, including:
an address memory device operatively connected to said switching apparatus, said address memory device having a memory content;
said common memory is configured such that a given signal prompts said common memory to perform an operation selected from the group consisting of reading data from said common memory and writing data to said common memory; and
said address memory device is configured such that the given signal also prompts said address memory device to increment the memory content.

15. The CPU system according to claim 1, wherein one of said other ones of said CPUs not connected to said address bus transmits data indicating to a relevant one of said plurality of CPUs a start address for an operation selected from the group consisting of reading data from said common memory and writing data to said common memory, when one of said plurality of CPUs, which is to be used for an access and is connected to said address bus, accesses said common memory.

16. The CPU system according to claim 1, wherein one of said other ones of said CPUs not connected to said address bus transmits an address indicating to a relevant one of said plurality of CPUs a start for an operation selected from the group consisting of reading data from said common memory and writing data to said common memory, when one of said plurality of CPUs, which is to be used for an access and is connected to said address bus, accesses said common memory.

17. The CPU system according to claim 15, including:
a switching apparatus operatively connected to said common memory;
an address memory device operatively connected to said switching apparatus;
a given one of said plurality of CPUs, which is used for the operation selected from the group consisting of reading data from said common memory and writing data to said common memory, outputting, to said address bus, the start address indicating a start for the operation selected from the group consisting of reading data from said common memory and writing data to said common memory;
said given one of said plurality of CPUs, which is used for the operation selected from the group consisting of reading data from said common memory and writing data to said common memory, driving said switching apparatus such that data stored in said address memory device are supplied to said common memory as an address; and
said given one of said plurality of CPUs, which is used for the operation selected from the group consisting of reading data from said common memory and writing data to said common memory, notifying a specific one of said plurality of CPUs, which requested access to said common memory, that said specific one of said plurality of CPUs is allowed to perform an operation selected from the group consisting of reading data from said common memory and writing data to said common memory.

18. The CPU system according to claim 1, wherein said other ones of said CPUs output signals, the signals representing addresses and being used as control signals for controlling system components.

19. The CPU system according to claim 1, wherein said other ones of said CPUs output signals, the signals representing addresses and being converted into control signals for controlling system components.

20. The CPU system according to claim 5, including:
a data bus connected to said address memory device;
said common memory outputting data read therefrom via said data bus; and
said address memory device outputting a content stored therein to said data bus when prompted by one of said CPUs.

21. The CPU system according to claim 20, wherein said address memory device is configured such that a signal for prompting said address memory device to output the content stored therein to said data bus has a signal profile dependent on addresses output by given ones of said CPUs, which are not connected to said address bus, for addressing memories connectable thereto.

22. A CPU system, comprising:
a plurality of CPUs including a first subset of CPUs and a second subset of CPUs;
a common memory provided for said plurality of CPUs;
an address bus for addressing said common memory;
only said first subset of said CPUs being connected to said address bus; and
said second subset of CPUs accessing said common memory via said first subset of CPUs.
